(19) United States
(12) Patent Application Publication
(10) Pub. No.: US 2007/0061195 A1
(43) Pub. Date: Mar. 15, 2007

(54) Framework for selecting and delivering advertisements over a network based on combined short-term and long-term user behavioral interests

(75) Inventors: Hongche Liu, Fremont, CA (US); M.S. Kiumarse Zamanian, Hillsborough, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/225,238

(22) Filed: Sep. 13, 2005

(51) Int. Cl. G06Q 30/00

(52) U.S. Cl. 705/14

(57) ABSTRACT

Targeted advertising content is provided for display in a page over a network in accordance with a technique in which advertisements are selected based on a determination of a user's short-term and long-term behavioral interests. Short-term and long-term information relating to a user's online activities is collected and associated with predetermined interest categories. Based on the collected information, short-term and long-term behavioral interest scores are determined for specific categories. The scores are employed to generate values for use in selecting advertisements. In one embodiment, a short-term score and two long-term scores are determined for one or more interest categories. A first long-term score models awareness with respect to a given category. A second long-term score and the short-term score are response-oriented scores that model the user's interest in making a response with respect to a given category, such as by purchasing a product or service within the category.

### FIELD OF THE INVENTION

The present invention relates generally to providing advertising content over a network, and more particularly, but not exclusively, to collecting information regarding user activities to determine scores for use in selecting and delivering advertisements.

### BACKGROUND OF THE INVENTION

Online advertising may be used by advertisers to accomplish various business goals, ranging from building brand awareness among potential customers to facilitating online purchases of products or services. A number of different kinds of page-based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a page to be configured to contain a location for inclusion of an advertisement. The advertisement can be selected dynamically each time the page is requested for display in a browser application.

Two exemplary kinds of online advertisements are banner advertisements and sponsored listing advertisements. A banner advertisement generally features an image (animated or static) and/or text displayed at a predetermined position in a page. The banner advertisement usually takes the form of a horizontal rectangle at the top of the page, but it can also be arranged in a variety of other shapes at any other location on the page. Typically, if a user clicks on the banner advertisement's location, image, and/or text, the user is taken to a new page that may provide detailed information regarding the products or services associated with the banner advertisement. Banner advertisements are often provided on a guaranteed number of impressions basis, though they may also be performance-based.

Sponsored listing advertisements can be represented by text and/or images that are displayed in a listing based on a user's search criteria or user browsing data. For example, if a user enters a search query in a web-based search engine, a set of hyperlinked text listings may be displayed in a position in the returned page along with the search query results. Sponsored listing advertisements are often provided according to a bidding model in which advertisers bid on keywords and the higher bids win placement in a listing, and pricing is often calculated on a “pay for clicks” and/or frequency basis.

Online advertising differs from traditional forms of advertising in that the target of the advertising effort is a user who typically is actively engaged in the interactive medium in which the advertising content is presented. Information regarding the online activities of such a user is often susceptible to recording and analysis. In principle, such behavioral information may be employed to focus particular advertising efforts on users whose online activities and behavior suggest that the user is a potential purchaser of the product or service being advertised. However, the development of effective and practical techniques for targeting online advertising in this way has remained an open problem.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following detailed description of the invention, which is to be read in association with the accompanying drawings, wherein:

FIG. 1 is a diagram illustrating one embodiment of an operating environment within which the invention may be practiced;

FIG. 2 is a diagram illustrating a framework for providing advertisements with behavioral targeting;

FIG. 3 is a diagram illustrating components of a behavioral targeting system that may be employed for selecting advertisements;

FIG. 4 illustrates a logical flow diagram generally showing one embodiment of a process for enabling the display of a page with an advertisement selected based on user behavioral interest scores;

FIG. 5 illustrates a logical flow diagram generally showing one embodiment of a process for selecting an advertisement based on user behavioral interest scores;

FIG. 6 illustrates a logical flow diagram generally showing one embodiment of a process for obtaining behavioral information related to user interests;

FIG. 7 illustrates a logical flow diagram generally showing one embodiment of a process for selecting an advertisement using values that are determined based on short-term and long-term behavioral interest scores; and

FIG. 8 is a diagram providing a conceptual illustration of functions for determining values for selecting advertisements using short-term and long-term behavioral interest scores in one embodiment of the invention.

### DETAILED DESCRIPTION OF THE INVENTION

The present invention will now be described more fully hereinafter with reference to the accompanying drawings, which form a part hereof, and which show, by way of illustration, specific exemplary embodiments by which the invention may be practiced. The invention may, however, be embodied in many different forms and should not be regarded as limited to the embodiments set forth herein. Rather, these embodiments are provided so that this disclosure will be thorough and complete and will convey fully the scope of the invention to those skilled in the art. The following detailed description is, therefore, not to be taken in a limiting sense.

The invention is directed towards providing targeted advertising content for display in a page over a network, such as a web page, in which advertisements are selected based on a determination of a user's short-term and long-term behavioral interests. The determination may include employing one or more heuristic techniques. Information relating to the user's online activities is obtained. Such information includes current or recent activities as well as activities occurring over a longer period of time. The information may be based, for example, on the user's browsing or other navigational activity, search-related activity, declared personal data submitted in a user account registration, and the like. The obtained information is mapped to, or otherwise associated with, one or more predetermined interest categories. From this categorized user activity information, user behavioral interest scores for specific categories are determined.

The determined user behavioral interest scores generally attempt to model the strength of the user's interest in purchasing a product or service within a given interest category. Short-term user interest scores as well as long-term user interest scores for particular categories are determined. Various methods for determining such scores may be employed. Generated scores may be modified over time as additional information is collected about the user and as older information is expired. A user's scores may be included in one or more behavioral interest profiles. If a user requests a page that is configured for inclusion of one or more advertisements, the user's short-term and long-term behavioral interest scores are employed to generate values for use in selecting advertisements to be included in the requested page. Advertisers may thereby target the distribution of advertising content towards users who may be expected to have a relatively strong interest in purchasing the product or service being advertised.

In one embodiment, two long-term scores are determined, as well as a short-term score. A first long-term score is an awareness score that models the user's awareness with respect to a given category. A second long-term score is a response-oriented score that models the user's interest in taking a specific action or engaging in another kind of response with respect to a given category, such as by making a purchase of a product or service associated with the given category. The values generated for selecting advertisements may be derived from the short-term and long-term behavioral interest scores using various techniques. In one embodiment, for each user, with respect to each category, an awareness boolean value and a response-oriented boolean value are determined for use in selecting banner advertisements by applying decay functions to the response-oriented short-term score and to the awareness or response-oriented long-term score, combining the results, and applying a threshold function. A scalar value within a certain range for use in selecting sponsored listing advertisements is determined by applying decay functions to the short-term and long-term response-oriented scores and combining the results. In another embodiment, a response score and an awareness score are output to an optimization module, which also stores advertisements and the price each advertiser is willing to pay to reach a qualified user. The optimization module determines the best advertisement based on the strengths of the user interests and the prices advertisers are willing to pay.

An embodiment of the invention may be deployed as part of a general system for providing behavior-targeted and personalized content for users. Various kinds of online advertisements may be provided in accordance with the invention, including, but not limited to, banner advertisements, sponsored listing advertisements, guaranteed impression advertisements, and performance-based advertisements, and including advertisements that employ media other than text or images, such as audio and/or video media.

Illustrative Operating Environment

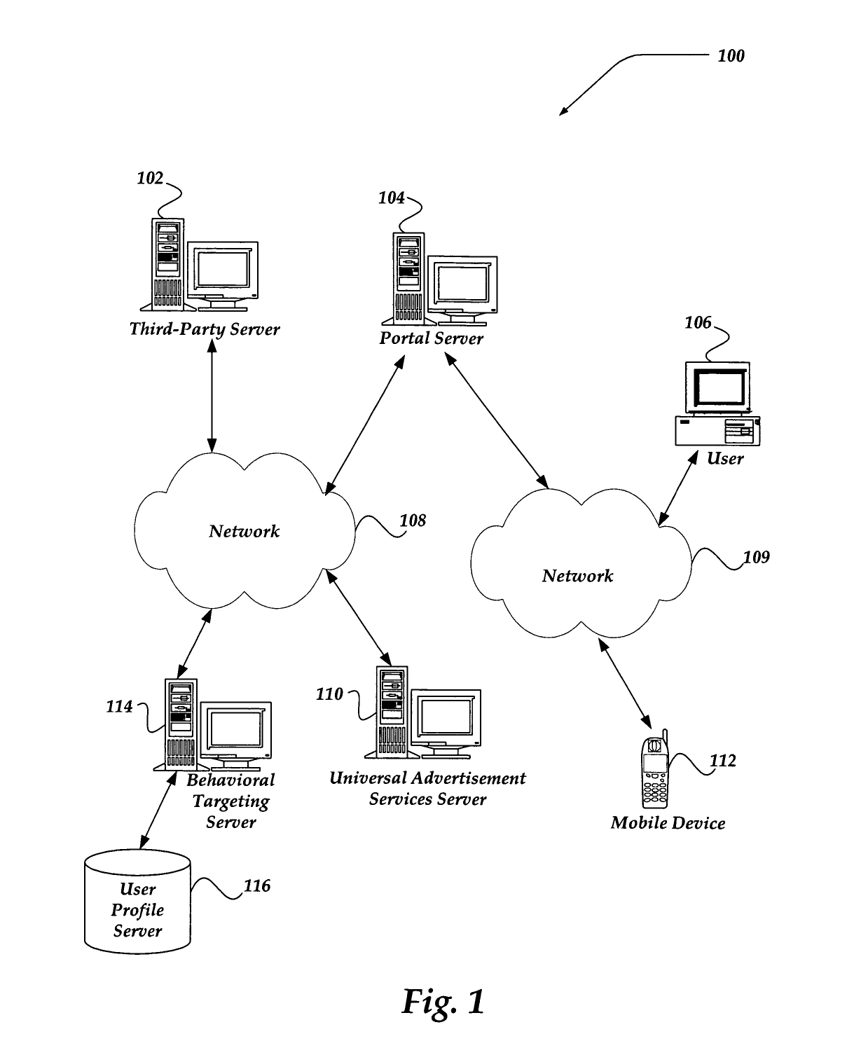

FIG. 1 provides a simplified view of one embodiment of an environment 100 in which the present invention may operate. Not all of the depicted components may be required to practice the invention, however. Variations in the arrangement and type of the components may be made without departing from the spirit or scope of the invention.

As illustrated in FIG. 1, environment 100 includes behavioral targeting server 114, which generates and makes available short-term and long-term user behavioral interest profiles of users who navigate pages, perform searches, and otherwise interact with sites hosted by portal server 104 and/or third-party server 102. Behavioral targeting server 114 is in communication with user profile server 116, which provides persistent storage of user behavioral interest profile data. In FIG. 1 users are represented by user 106 (here depicted as a conventional personal computer) and web-enabled mobile device 112. Environment 100 also includes universal advertisement services server 110, which provides a unified platform for selection and distribution of advertisements for inclusion in pages provided by portal server 104 and third-party server 102. The user behavioral interest profiles generated and retrieved by behavioral targeting server 114 and persistently maintained by way of user profile server 116 are based at least in part on user activity information obtained, for example, from universal advertising services server 110, portal server 104, third-party server 102, and/or other components not explicitly shown in FIG. 1.

Behavioral targeting server 114, universal advertisement services server 110, portal server 104, and third-party server 102 are in communication by way of network 108. It will be understood that behavioral targeting server 114, universal advertisement services server 110, and portal server 104 may each represent multiple linked computing devices, and multiple third-party servers, such as third-party server 102, may be included in environment 100. Network 108 may be regarded as a private network connection and may include, for example, a virtual private network or an encryption or other security mechanism employed over the public Internet, or the like.

User 106 and mobile device 112 represent devices that typically run browser applications and the like. Such devices are in communication with portal server 104 and/or third-party server 102 by way of network 109. (The link between third-party server 102 and network 109 is not explicitly shown in FIG. 1.) Network 109 may be the public Internet and may include all or part of network 108; network 108 may include all or part of network 109.

Portal server 104, third-party server 102, behavioral targeting server 114, universal advertisement services server 110, user device 106, and mobile device 112 each represent computing devices of various kinds. Such computing devices may generally include any device that is configured to perform computation and that is capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, user device 106 may be configured to execute a browser application that employs HTTP to request information, such as a web page, from a web server, which may be a program executing on portal server 104 or third-party server 102.

Networks 108-109 are configured to couple one computing device to another computing device to enable communication of data between the devices. Networks 108-109 may generally be enabled to employ any form of machine-readable media for communicating information from one device to another. Each of networks 108-109 may include one or more of a wireless network, a wired network, a local area network (LAN), a wide area network (WAN), a direct connection such as through a Universal Serial Bus (USB) port, and the like, and may include the set of interconnected networks that make up the Internet. On an interconnected set of LANs, including networks employing differing protocols, a router acts as a link between LANs, enabling messages to be sent from one to another. Communication links within LANs typically include twisted wire pair or coaxial cable. Communication links between networks may generally use analog telephone lines, full or fractional dedicated digital lines including T1, T2, T3, and T4, Integrated Services Digital Networks (ISDNs), Digital Subscriber Lines (DSLs), wireless links including satellite links, or other communication links known to those skilled in the art. Remote computers and other network-enabled electronic devices may be remotely connected to LANs or WANs by way of a modem and temporary telephone link. In essence, networks 108-109 may include any communication method by which information may travel between computing devices.

The media used to transmit information across information links as described above illustrate one type of machine-readable media, namely communication media. Generally, machine-readable media include any media that can be accessed by a computing device or other electronic device. Machine-readable media may include processor-readable media, data storage media, network communication media, and the like. Communication media typically embody information comprising computer-readable instructions, data structures, program components, or other data in a modulated data signal such as a carrier wave, data signal, or other transport mechanism, and such media include any information delivery media. The terms “modulated data signal” and “carrier-wave signal” include a signal that has one or more of its characteristics set or changed in such a manner as to encode information, instructions, data, and the like, in the signal. By way of example, communication media include wired media such as twisted pair, coaxial cable, fiber optic cable, and other wired media, and wireless media such as acoustic, RF, infrared, and other wireless media.

Framework for Behavioral Targeting of Advertisements

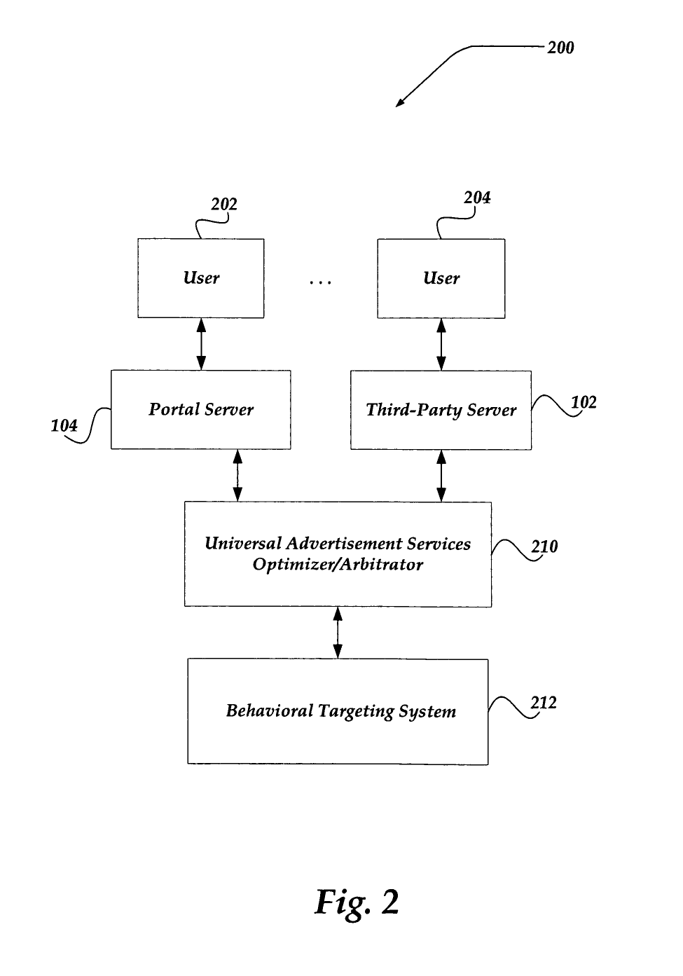

FIG. 2 is a diagram illustrating a framework 200 for providing advertisements with behavioral targeting. At the top level are users 202-204, who may correspond to user 106 and mobile device 112 of FIG. 1. Users 202-204, running browser applications or the like, navigate and interact with pages over a network by communicating over the network with portal server 104 and/or third-party server 102. The communication includes making requests for pages provided by portal server 104 or third-party server 102 and may include providing data, such as search query terms. If a requested page is configured for inclusion of one or more advertisements, such as banner advertisements or sponsored listing advertisements, portal server 104 or third-party server 102 communicates with universal advertisement services optimizer/arbitrator 210, which may be a component of universal advertisement services server 110 of FIG. 1, and which determines and selects from among advertisements that qualify for inclusion in the requested page.

Universal advertisement services optimizer/arbitrator 210 in turn communicates with behavioral targeting system 212, which may correspond to behavioral targeting server 114 of FIG. 1. In communicating with behavioral targeting system 212, optimizer/arbitrator 210 requests short-term and long-term user behavioral interest profiles associated with the user requesting the page, who is identified by way of a cookie or another identifying mechanism. Optimizer/arbitrator 210 manipulates scores contained in the retrieved user behavioral interest profiles to produce values for use in selecting appropriate advertisements to be included in the page requested by the user.

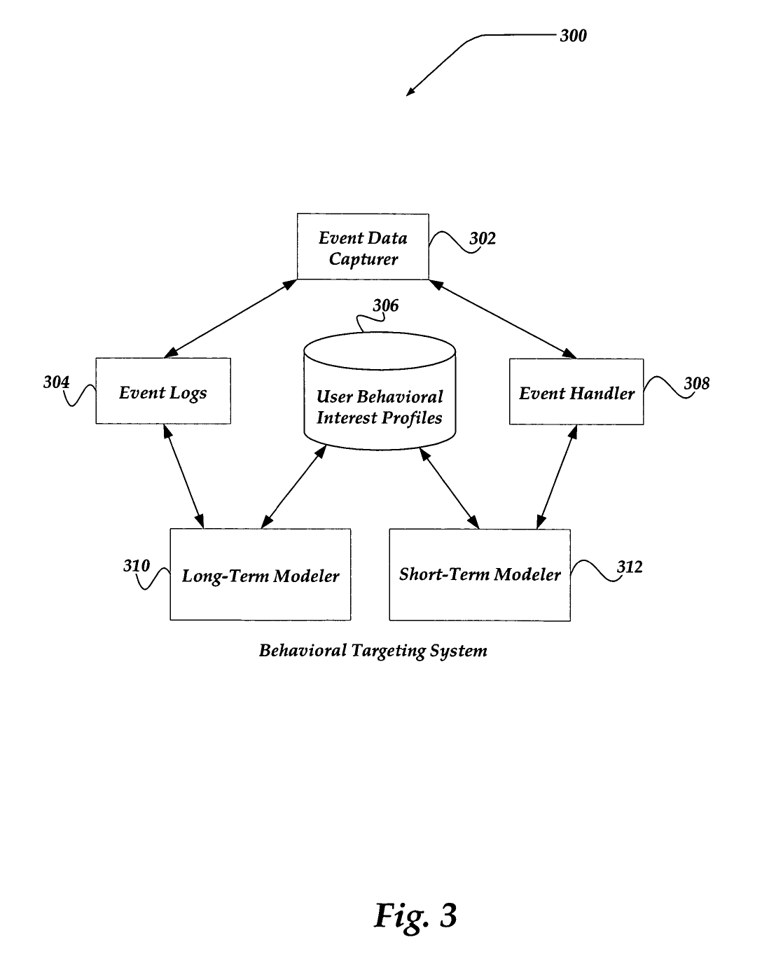

FIG. 3 illustrates components that may form a part of behavioral targeting system 212. Behavioral targeting system 212 includes long-term modeler 310 and short-term modeler 312, which are employed to generate and update long-term and short-term persistently-stored user behavioral interest profiles 306, which may be associated with user profile server 116 of FIG. 1. The use of both long-term and short-term behavioral interest profiling enables targeting of advertising content based on user behavior that is manifested over an extended period of time and multiple sessions as well as on immediate or very recent user activity. Long-term modeler 310 obtains collected user activity data from event logs 304 derived from data captured by event data capturer 302. Long-term modeler may also obtain user information from other sources not explicitly shown in FIG. 3, such as user-declared personal attributes stored for use in content personalization. Long-term modeler 310 maps the event data to predetermined interest categories and generates long-term user behavioral interest scores, employing these scores to construct a long-term user behavioral interest profile for the user.

Short-term modeler 312 obtains short-term user activity information from event handler 308. Event handler 308 obtains and processes recent or real-time user activity information from event data capturer 302 or other sources not explicitly shown in FIG. 3, such as an event observer. Examples of event data obtained by event handler 308 include advertisement clicks, search query keywords, search clicks, sponsored listing clicks, page views, advertisement page views, and other kinds of online navigational, interactive, and/or search-related events. Event handler 308 maps the event into an interest category having a certain weight. For example, if the event is a page view, the page may be associated with a particular category based on page content that has been categorized through an editorial process or by way of a semantic engine or the like. If the event is a search query, the search keywords are parsed and categorized. Short-term modeler 312 uses the converted event data to determine new or updated short-term behavioral interest scores for a user.

The determination of how far into the past “short term” extends, and thus the boundary between “short term” and “long term,” may be specific to particular implementations and administrative policies. For both short-term and long-term scoring, a score within a given interest category may attempt to model the strength of the user's interest in purchasing a product at a particular time. For example, if the user conducts a search for “digital cameras,” a score within the interest category Cameras->Digital may be incremented by a small amount. If the same user begins to view pages or click on advertisements relating to specific models of digital cameras, the score in Cameras->Digital is incremented further by a larger amount. If the user examines prices at specific store sites, manifesting a specific intent to purchase a particular digital camera model, the score in Cameras->Digital may be raised further to a very high amount, possibly to a maximum level. In general, users may be expected to have higher scores for lower-priced items, such as flowers. By contrast, for higher-priced products and services, such as automobiles or mortgages, a user may be expected to have lower scores during an initial period before the scores increase to higher levels when the user demonstrates a strong intent to make a purchase.

Long-term scores may be determined based on the use of predetermined models, such as by employing neural networks, and may be based on periodic batch processing of captured user event data and the like. A short-term score may be determined in many ways. For example, a strong intent to purchase a product or service within an interest category may be associated with specific web pages or search keywords. A relative distance from those pages or keywords may then be determined for a particular page or site. Accordingly, as a user approaches the “intent” destination pages, the user's score for the associated interest category is incremented. A decay function may be used to modify a score to reflect an absence of activity in a given interest category over a period of time.

User behavioral interest profiles 306 generally include a long-term profile and a short-term profile for each tracked user. A profile generally includes a vector of predetermined interest categories, each associated with one or more scores. In one embodiment, a long-term behavioral interest profile may include two scores for each category: an awareness score and a response-oriented score. The awareness score determines a user's awareness of and basic interest in products and services within the given category. Such a score may be employed, for example, in directing branding or brand awareness advertising efforts. The response-oriented score determines a user's interest in making a purchase of a product or service within the given category or engaging in another kind of response with respect to the category. The response-oriented score may be useful for direct marketing advertisement efforts or for other advertisement efforts in which the targeted customer may be likely to make a decision to purchase within the near future. In one embodiment, a response-oriented short-term score is associated with the short-term behavioral interest profile.

For a given user, two sets of profiles may be maintained for anonymous (non-logged-in) user behavior and for logged-in user behavior, with the latter modeling activity of the user while the user is logged in under a registered user account on a site or network of sites.

Providing Advertisements Based on Combined Short-Term and Long-Term User Behavioral Interests

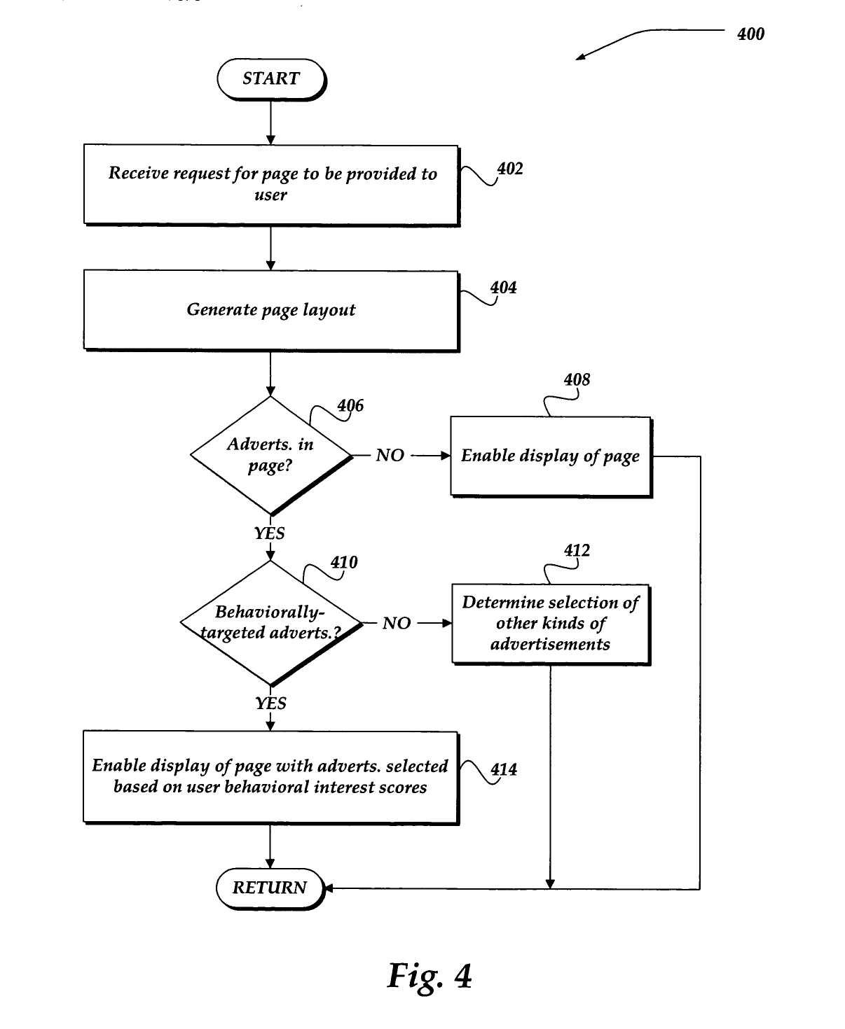

The operation of certain aspects of the invention will now be described with respect to FIGS. 4-8, including the logical flow diagrams of FIGS. 4-7, which illustrate elements of processes for selecting and delivering an advertisement for inclusion in a position in a page based on a determination of short-term and long-term user behavioral interests. It will be appreciated that the order of operations presented in the flow diagrams is illustrative and does not preclude a different ordering, unless context indicates otherwise.

FIG. 4 is a flow diagram illustrating a process 400 for enabling the display of a page with an advertisement selected based on user behavioral interest scores. Following a start block, process 400 flows to block 402, where a request for a page (for example, a request for a web page from a web browser client application operated by a user) is received over a network (for example, by a web server). Next, at block 404, the page layout and content for the requested page is generated (for example, by a web server). Process 400 then flows to decision block 406, at which it is determined whether the page is formatted for inclusion of one or more advertisements at particular locations in the page. If there is no advertisement to be included in the page, process 400 branches to block 408, where the display of the requested page is enabled, and processing flows to a return block and performs other actions.

If, however, the page is configured for inclusion of at least one advertisement, process 400 advances to decision block 410, at which it is determined whether the one or more advertisements target user behavior or some other user attribute, such as gender or geographical location. If not, processing steps to block 412, where selection of other kinds of targeted advertisements is determined, following which process 400 returns to perform other actions. If, however, the advertisements are behaviorally-targeted advertisements, processing branches to block 414, where the display of the page with the advertisement or advertisements at specified locations in the page is enabled. The advertisements are selected based on determinations of behavioral interest scores associated with the requesting user. Processing then flows to a return block and performs other actions. It will be appreciated that the flow diagram of FIG. 4 presents process 400 in a simplified form for illustrative purposes. A page may be configured for inclusion of an advertisement that targets more than one kind of user attribute or characteristic, including both behavioral profiling as well as other kinds of targeting.

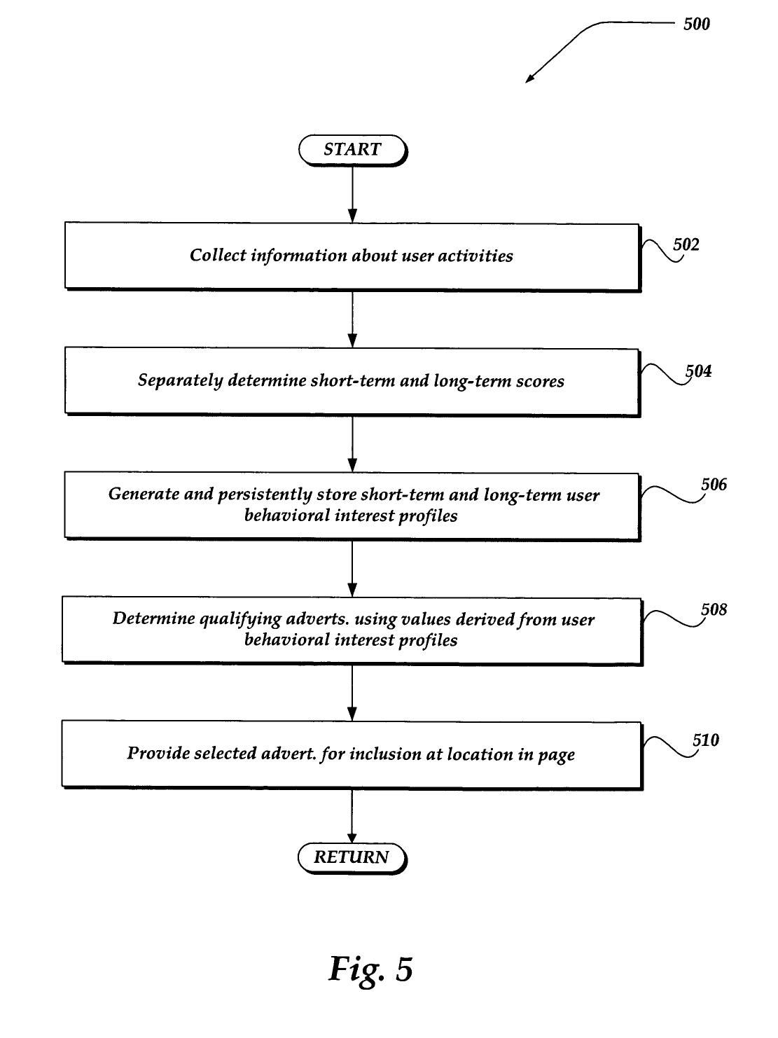

FIG. 5 is a flow diagram illustrating aspects of a process 500 for selecting an advertisement to be provided to a user based on behavioral interest scores. After a start block, process 500 flows to block 502, where information about a user's online activities, such as navigational and search-related behavior, is collected in logs. The information includes recent or current activity data, as well as information collected over a longer period of time. Next, at block 504, short-term and long-term behavioral interest scores are determined separately for the user. Short-term scores are based on current or recent user activity data that is mapped to predetermined interest categories. Long-term scores are based on longer-term user activity data mapped to predetermined interest categories. Long-term scores may be determined based on the use of predetermined models, such as by employing neural networks. The determined scores may be updated based on new or recently-obtained user activity data. In some cases, at a particular time, a given user might not have associated short-term and/or long-term score information, depending on the user's online activities. Processing next flows to block 506, at which short-term and long-term behavioral interest profiles associated with a particular user are generated and persistently stored based on the short-term and long-term scores. In one embodiment, a user behavioral interest profile includes both short-term and long-term score information.

Process 500 next steps to block 508, where advertisements qualifying for inclusion in the requested page are determined using values derived from the user behavioral interest profiles. The values may be derived in various ways, including by application of decay functions and threshold functions to the short-term and long-term scores and by combining the scores. The process then flows to block 510, where a qualifying advertisement is selected and is provided for inclusion at a location in a page requested by the user. Process 500 then flows to a return block and performs other actions.

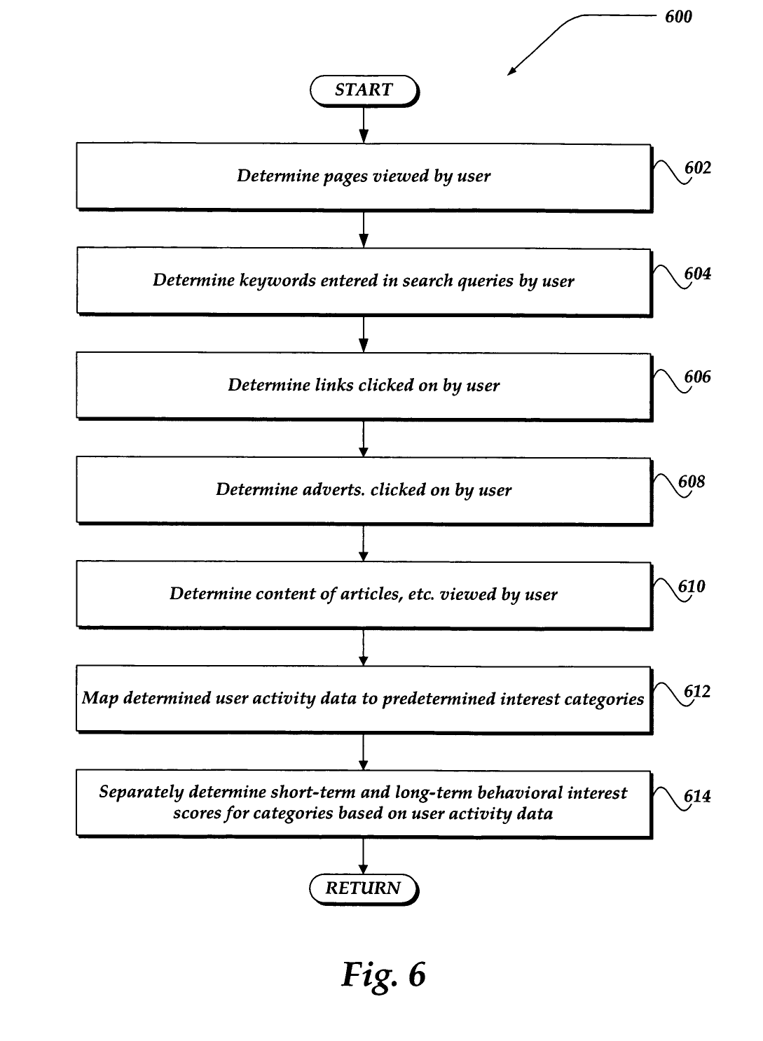

FIG. 6 is a flow diagram illustrating a process 600 for obtaining behavioral information related to user interests and determining behavioral interest scores based on the obtained information. Blocks 602-610 refer to different kinds of online user activities that are recorded to infer general and specific interests of the user. Following a start block, process 600 flows to block 602, at which pages viewed by the user, a form of navigational user activity, are determined. Pages may be associated with particular subject matter; for example, a page may be a sports-content or a finance-content page provided as part of a larger portal service site, or a page may contain an article of a particular topic (for example, an article on best-selling automobiles). A page may be identified by its Uniform Resource Locator (URL) or by another identifying mechanism. At block 604, keywords used in search queries entered by the user, and other search-related user activity data, are determined. For example, a user who enters a search for “digital camera” may be assumed to have an interest in digital photography and in potentially purchasing digital cameras and related products or services, and this fact may be recorded. At block 606, links clicked on by the user (such as sponsored advertisement links) are determined. At block 608, advertisements clicked on by the user (such as banner advertisements) are determined. At block 610, the content of material in pages viewed by the user, such as the content of an article included in a particular page, is determined.

Process 600 next flows to block 612, where the determined user activity data is mapped to predetermined interest categories. The interest categories may be organized hierarchically by subject-matter, such as Autos->SUV->European or Cameras->Digital. The mapping may be accomplished by an editorial means and/or through an automated means. Next, processing steps to block 614, at which short-term and long-term behavioral interest scores are separately determined for the categories based on the determined user activity data. In one embodiment, weights are determined for the events in the user activity data, which may measure the strength of the mapping of the event to the interest category. The behavioral interest scores for an interest category are then determined from the event weights within the category. Process 600 then flows to a return block and performs other actions.

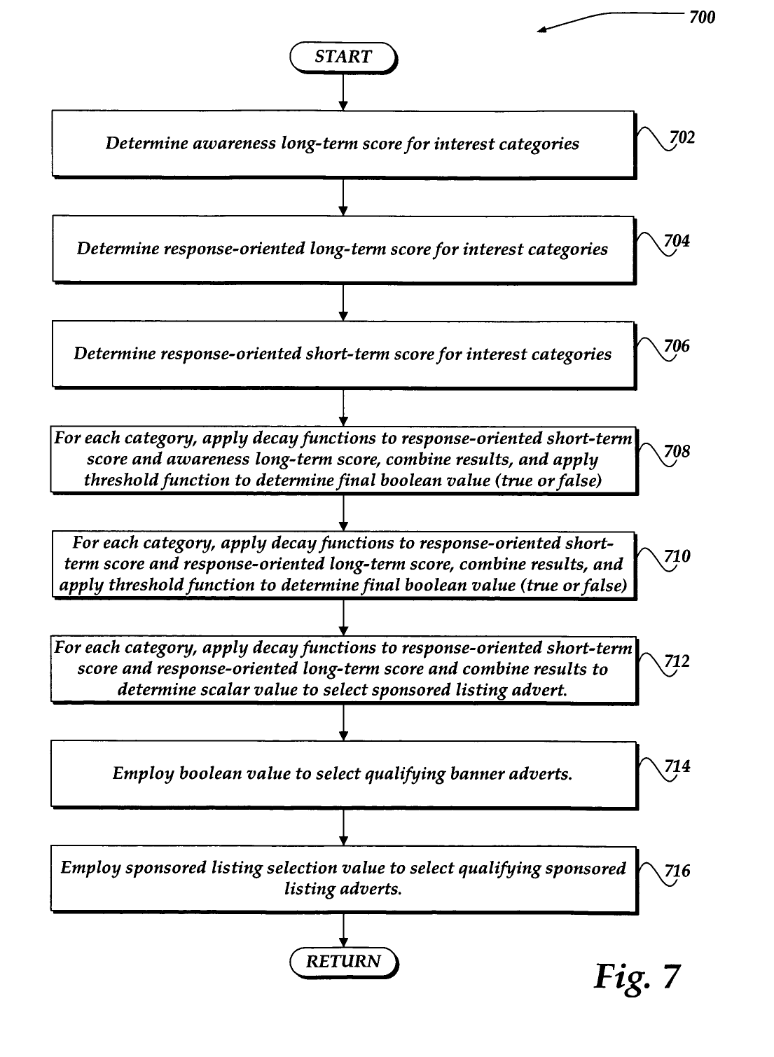

FIG. 7 is a flow diagram illustrating a process 700 for selecting an advertisement using values that are determined based on short-term and long-term behavioral interest scores for one or more interest categories. Following a start block, processing steps to block 702, where an awareness long-term score is determined for each of the one or more interest categories. At block 704, a response-oriented long-term score is determined for each of the one or more interest categories. Process 700 next flows to block 706, where a new or updated response-oriented short-term score for one or more interest categories is determined. A new short-term score may be based on a triggering event associated with the user's immediate page request, such as a page view. The determination of long-term and short-term interest scores may include updating or replacing previously-determined scores.

Process 700 continues at block 708, where, for each available category, decay functions are applied to the response-oriented short-term score and the awareness long-term score, the results are combined, and a threshold function is applied, producing a boolean value (true or false). At block 710, for each available category, decay functions are applied to the response-oriented short-term score and the response-oriented long-term score, the results are combined, and a threshold function is applied, producing a boolean value (true or false). At block 712, for each available category, decay functions are applied to the response-oriented short-term score and the response-oriented long-term score to produce a scalar value within a range. Process 700 then flows to block 714, at which the determined boolean values are employed to select qualifying banner advertisements, from which one or more banner advertisements are chosen to be provided to the user. At block 716 the scalar value is used to select qualifying sponsored listing advertisements, from which one or more sponsored listing advertisements are chosen to be provided to the user. Next, process 700 flows to a return block and performs other actions.

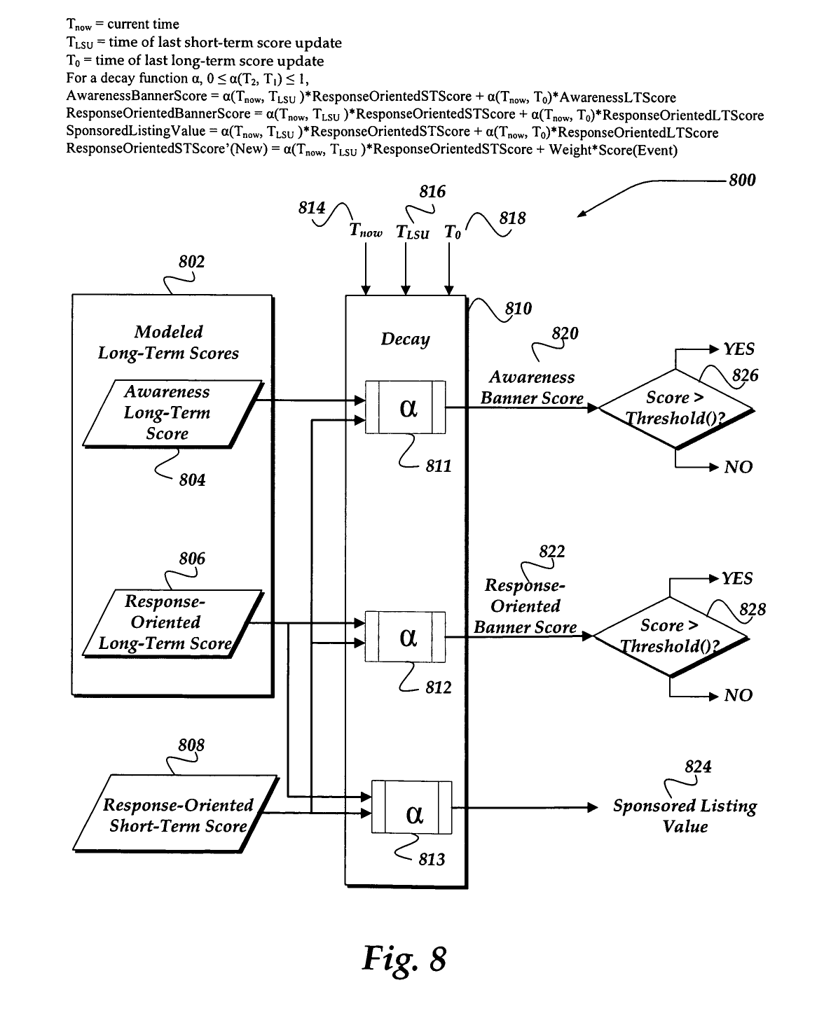

The diagram in FIG. 8 illustrates further the process by which short-term and long-term behavioral interest scores associated with a user are employed to determine values that are used in selecting qualifying advertisements to be provided to the user. As depicted in the diagram, for each predetermined interest category, inputs include short-term score 808 and long-term scores 802. Long-term scores 802 may be determined using one or more modeling techniques. The modeled long-term scores 802 include awareness score 804 and response-oriented score 806. Decay functions 810 are applied to these scores. Here the decay functions are denoted generally by α, but it will be appreciated that decay functions may be specific to particular interest categories and particular kinds of scores. In general, a decay function α(T₂, T₁) is used to model the effect of time that has passed between a current time T₂ and the time T₁ of the most recent recorded activity or score update. Inputs into decay functions 810 include T_{now} 814 (the current time) and either T_{LSU} 816 (the time of a previous short-term score update) or T₀ 818 (the time of a previous relevant long-term score update). The values for T_{LSU} and T₀ may be determined based on recorded timestamps.

As illustrated in FIG. 8, for a given interest category, awareness banner advertisement selection score 820 is determined by applying a decay function to response-oriented short-term score 808, applying a decay function to awareness long-term score 804, and combining the results:
AwarenessBannerScore=α(T_{now}, T_{LSU})*ResponseOrientedSTScore+α(T_{now}, T₀)*AwarenessLTScore
For a given interest category, response-oriented banner advertisement selection score 822 is determined by applying a decay function to response-oriented short-term score 808, applying a decay function to response-oriented long-term score 806, and combining the results:
ResponseOrientedBannerScore=α(T_{now}, T_{LSU})*ResponseOrientedSTScore+α(T_{now}, T₀)*ResponseOrientedLTScore
Threshold functions 826, 828 are applied to awareness banner advertisement selection score 820 and response-oriented banner advertisement selection score 822, respectively, producing, in each case, a boolean value depending on whether the input score exceeds a given threshold. For a given interest category, sponsored listing advertisement value 824 is determined by applying a decay function to short-term score 808, applying a decay function to response-oriented score 806, and combining the results:
SponsoredListingValue=α(T_{now}, T_{LSU})*ResponseOrientedSTScore+α(T_{now}, T₀)*ResponseOrientedLTScore

As indicated in FIG. 8, for a given category, an updated response-oriented short-term score may be generated by applying a decay function to current response-oriented short-term score 808 and combining the result with a weighted event score, where the event is a recent user activity event:
ResponseOrientedSTScore′(New)=α(T_{now}, T_{LSU})*ResponseOrientedSTScore+Weight*Score(Event)

The following table provides a simplified illustration of the use of the processes illustrated in FIGS. 6 and 7 to determine values for selecting qualifying banner advertisements and sponsored listing advertisements.

| | Response- | Aware- | Response- | | | |
|---|---|---|---|---|---|---|
| | Oriented | ness | Oriented | | | |
| | Short- | Long- | Long- | Aware- | Response- | Spon- |
| | Term | Term | Term | ness | Oriented | sored |
| Case | Score | Score | Score | Banner | Banner | Listing |
| 1 | 0 | 0 | 0 | N | N | N |
| 2 | 1 | 0 | 0 | Y | Y | Y |
| 3a | 0 | 0 | 1 | N | Y | Y |
| 3b | 0 | 1 | 0 | Y | N | N |
| 3c | 0 | 1 | 1 | Y | Y | Y |
| 4a | 1 | 0 | 1 | Y | Y | Y |
| 4b | 1 | 1 | 0 | Y | Y | Y |
| 4c | 1 | 1 | 1 | Y | Y | Y |

Here, for purposes of illustrative simplicity, inputs (the second, third, and fourth columns of the table) are treated as binary and correspond to various cases (the first column of the table), and outputs (the fifth, sixth, and seventh columns) are also binary. It may also be assumed here for simplicity that awareness banner advertisements are employed for branding purposes and that response-oriented banner advertisements are employed for direct marketing. In case 1, the user is a new user for whom there is no long-term or short-term score yet available. An initial response-oriented short-term score in a given category is generated based on the event that triggered the lookup for user behavioral interest profile information. The user may be provided with banner advertisements and/or sponsored listing advertisements if the initial response-oriented short-term score exceeds a certain threshold. In case 2, the user is a recent user with little activity history; the user has no long-term scores but has some short-term scores. This case is similar to case 1, except that the aggregate short-term score is likely to be higher and there are likely to be short-term scores in more categories, therefore qualifying the user for more advertisements in more categories.

In cases 3a, 3b, and 3c, the user is a low-activity user who has no short-term scores but has some long-term scores. If the user has response-oriented long-term scores (case 3a), the user may be provided with direct marketing banner advertisements, and/or the user may be provided with sponsored listing advertisements. If the user has awareness long-term scores (case 3b), the user may be provided with branding banner advertisements. If both kinds of long-term scores are available (case 3c), the user may be provided with branding and direct marketing banner advertisements as well as with sponsored listing advertisements. For interest categories in which the user shows activity, a short-term score is expected to build quickly.

In cases 4a, 4b, and 4c, the user is a high-activity user who has some long-term scores and some short-term scores. If the user does not have an awareness long-term score (case 4a), the user may be provided with branding banner advertisements in those interest categories for which the user has short-term scores. If the user does not have a response-oriented long-term score (case 4b), the user may be provided with direct marketing banner advertisements and/or sponsored listing advertisements in interest categories for which the user has short-term scores. In case 4c, the user has awareness and response-oriented long-term scores as well as short-term scores. Here the user may be provided with branding and/or direct marketing banner advertisements as well as sponsored listing advertisements.

The above specification provides a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for providing advertising content for display in at least one page over a network, comprising:
obtaining information based on at least one activity associated with a user;
employing the obtained information to provide a plurality of scores that determine an interest of the user in at least one category, wherein the plurality of scores include a short-term score and at least one long-term score; and
employing the plurality of scores to select an advertisement to be displayed in the page.

2. The method of claim 1, wherein the at least one activity comprises past activities of the user.

3. The method of claim 1, wherein the advertisement includes at least one of a banner advertisement, a sponsored listing advertisement, a guaranteed impression advertisement, or a performance-based advertisement.

4. The method of claim 1, wherein the obtained information is based at least in part on one of a navigational activity or a search activity.

5. The method of claim 1, wherein the at least one long-term score includes at least one of an awareness score for the category or a response-oriented score for the category.

6. The method of claim 1, wherein the short-term score is a response-oriented score for the category.

7. The method of claim 1, wherein employing the plurality of scores to select the advertisement further comprises applying a decay function to at least one score.

8. The method of claim 1, wherein employing the plurality of scores to select the advertisement further comprises applying a threshold function to determine a value.

9. A server for providing advertising content for display in at least one page over a network, comprising:
a memory for use in storing data and instructions; and
a processor in communication with the memory and for enabling actions based on the stored instructions, including:
obtaining information based on at least one activity associated with a user;
employing the obtained information to provide a plurality of scores that determine an interest of the user in at least one category, wherein the plurality of scores include a short-term score and at least one long-term score; and
employing the plurality of scores to select an advertisement to be displayed in the page.

10. The server of claim 9, wherein the at least one activity comprises past activities of the user.

11. The server of claim 9, wherein the advertisement includes at least one of a banner advertisement, a sponsored listing advertisement, a guaranteed impression advertisement, or a performance-based advertisement.

12. The server of claim 9, wherein the obtained information is based at least in part on one of a navigational activity or a search activity.

13. The server of claim 9, wherein the at least one long-term score includes at least one of an awareness score for the category or a response-oriented score for the category.

14. The server of claim 9, wherein the short-term score is a response-oriented score for the category.

15. The server of claim 9, wherein employing the plurality of scores to select the advertisement further comprises applying a decay function to at least one score.

16. The server of claim 9, wherein employing the plurality of scores to select the advertisement further comprises applying a threshold function to determine a value.

17. A client for displaying advertising content in at least one page over a network, comprising:
a memory for use in storing data and instructions; and
a processor in communication with the memory and for enabling actions based on the stored instructions, including:
enabling a retrieval of information associated with at least one activity of a user;
causing a plurality of scores to be provided based on the retrieved information, wherein the plurality of scores determine an interest of the user in at least one category, and wherein the plurality of scores include a short-term score and at least one long-term score; and
enabling a selection of an advertisement to be displayed in the page based on at least one of the plurality of scores.

18. The client of claim 17, wherein the at least one activity comprises past activities of the user.

19. The client of claim 17, wherein the advertisement includes at least one of a banner advertisement, a sponsored listing advertisement, a guaranteed impression advertisement, or a performance-based advertisement.

20. The client of claim 17, wherein the retrieved information is based at least in part on one of a navigational activity or a search activity.

21. The client of claim 17, wherein the at least one long-term score includes at least one of an awareness score for the category or a response-oriented score for the category.

22. The client of claim 17, wherein the short-term score is a response-oriented score for the category.

23. The client of claim 17, wherein enabling the selection of the advertisement further comprises applying a decay function to at least one score.

24. The client of claim 17, wherein enabling the selection of the advertisement further comprises further comprises applying a threshold function to determine a value.

25. A mobile device for displaying advertising content in at least one page over a network, comprising:
a memory for use in storing data and instructions; and
a processor in communication with the memory and for enabling actions based on the stored instructions, including:
enabling a retrieval of information associated with at least one activity of a user;
causing a plurality of scores to be provided based on the retrieved information, wherein the plurality of scores determine an interest of the user in at least one category, and wherein the plurality of scores include a short-term score and at least one long-term score; and
enabling a selection of an advertisement to be displayed in the page based on at least one of the plurality of scores.

26. A processor-readable medium having processor-executable code thereon for providing advertising content for display in a page over a network, comprising:
obtaining information based on at least one activity associated with a user;
employing the obtained information to provide a plurality of scores that determine an interest of the user in at least one category, wherein the plurality of scores include a short-term score and at least one long-term score; and
employing the plurality of scores to select an advertisement to be displayed in the page.
